(19) United States
(12) Patent Application Publication
(10) Pub. No.: US 2020/0200286 A1
(43) Pub. Date: Jun. 25, 2020

(54) REGULATING VALVE

(71) Applicant: XIA TAI XIN SEMICONDUCTOR (QING DAO) LTD., Qingdao (CN)

(72) Inventors: GEUNHO KIM, Singapore (SG); SUNG-WOON CHOO, Singapore (SG)

(21) Appl. No.: 16/663,379

(22) Filed: Oct. 25, 2019

Related U.S. Application Data
(60) Provisional application No. 62/782,369, filed on Dec. 20, 2018.

(51) Int. Cl. F16K 17/04

(52) U.S. Cl. CPC F16K 17/0413

(57) ABSTRACT

A regulating valve is disclosed. The regulating valve includes a cover mechanism and a controller controlling the cover ring. The cover mechanism includes a plurality of blades that forms a cover for a valve port of the regulating valve. When the plurality of blades are pulled away from each other, an opening formed by the plurality of blades is centered and flows uniform through to the process chamber.

### CROSS-REFERENCES TO RELATED APPLICATIONS

This application claims the benefit of U.S. Provisional Patent Application No. 62782369 filed on Dec. 20, 2018, which is hereby incorporated by reference herein and made a part of specification.

### BACKGROUND

### 1. Field

The present disclosure generally relates to regulating valve, and more particularly, regulating valve for controlling uniformity of exhaust flow in processing chamber.

### 2. Description of the Related Art

In semiconductor device manufacturing equipment, pendulum valve is commonly utilized for controlling the air pressure situation in a chamber of fabrication equipment with a vacuum pump system. Typical pendulum valve is shaped as a circular disk. When the grip of the pendulum valve is rotated in a certain direction (e.g., clockwise), the valve may be open like the change of the moon phase in a specific speed by a motor. The gas in the process chamber may thus be extracted from the chamber by the vacuum pump system through the pendulum valve. Because the shape of the opened area of the pendulum valve is not central symmetric, turbulence of gasflow may be induced in the chamber during operation of the pendulum valve. The amount of turbulence generated may be proportional to the operating speed of the pendulum valve. This kind of gas turbulence may lead to undesirable issues, such as misalignment of the angle of the parts in the process chamber, and negatively affects process uniformity, thus resulting in undesired defects. Furthermore, if the speed of opening the pendulum valve was setup slower, process time will be increased and thus affecting fabrication efficiency.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an apparatus according to some embodiments of the present disclosure;

FIG. 2 illustrates a planar view of a cover mechanism according to some embodiments of the present disclosure;

FIG. 3 illustrates a cross section of neighboring blades according to some embodiments of the present disclosure;

FIG. 4A illustrates a cross section of a cover mechanism according to some embodiments of the present disclosure;

FIG. 4B illustrates another cross section of a cover mechanism according to some embodiments of the present disclosure;

FIG. 5A-5D illustrates an actuator according to some embodiments of the present disclosure; and

FIG. 6 illustrates a flowchart for a method of operating an apparatus according to some embodiments of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

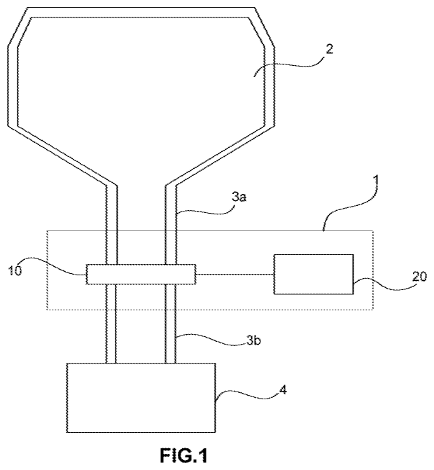

FIG. 1 is an schematic illustration of an apparatus according to some embodiments of the present disclosure. The apparatus may be used in a semiconductor fabrication process that needs precise control of the gas pressure. The exemplary apparatus comprises a processing chamber 2, an exhaust system 4, exhaust/circulation pipes 3a and 3b, and a regulating valve 1. When using the process chamber 2 to perform semiconductor fabrication process such as plasma etching, exhaust system 4 may be used to extract processing gas inside the process chamber 2. The exhaust system 4 may be coupled to the process chamber 2 through the exhaust pipes 3a and 3b. The regulating valve 1 is used to control the pressure in the processing chamber 2. The regulating valve 1 is disposed between the exhaust pipes 3a and 3b. The regulating valve 1 includes a cover mechanism 10 and a controller 20 coupled to the cover mechanism 10.

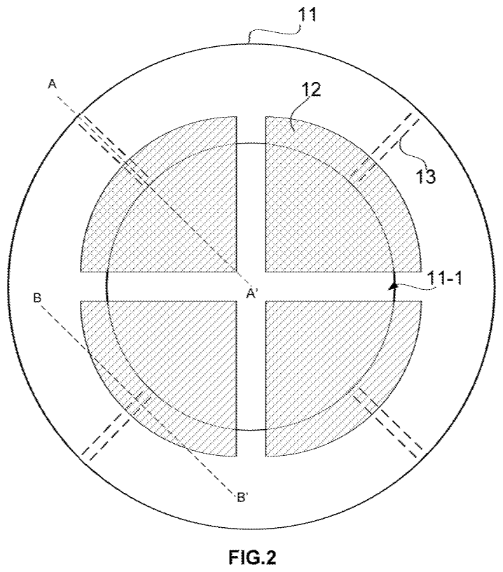

FIG. 2 illustrates a planar view of a cover mechanism according to some embodiments of the present disclosure. The cover mechanism includes a valve port 11, a plurality of blades 12, and a plurality of stems 13 respectively coupled to the plurality of blades 12. The valve port 11 defines a central opening 11-1. The plurality of blades 12 are symmetrically movable with respect to a center of the central opening 11-1 between an open position and a closed position. During the closed position, the plurality of blades 12 forms a cover for the central opening 11-1 of the valve port 11 to retain vacuum within the processing chamber during a semiconductor fabrication process. When pressure needs to be released from the processing chamber, the plurality of blades 12 are moved toward the open position. Since the opening formed between the plurality of blades 12 starts at the center of the valve port 11, the gasflow through the valve port 11 is going to be centered and flows uniformly to the process chamber. To transition from open position to closed position or vice versa, the plurality of blades 12 may move in a direction towards or away from the outer periphery of the valve port 11. In some embodiments, when the cover mechanism is in the open position, the plurality of blades 12 are arranged at a same distance from a center of the valve port 11. The plurality of blades 12 form a plurality of linear segment openings intersecting at a center of the valve port 11. During the valve blade opening process, the central opening 11-1 may not be fully cleared of the plurality of blades 12. In some embodiments, the movement and synchronization of the plurality of blades 12 are controlled by the plurality of stems 13. Each of the plurality of stems 13 are arranged perpendicular to a tangential line of the valve port 11.

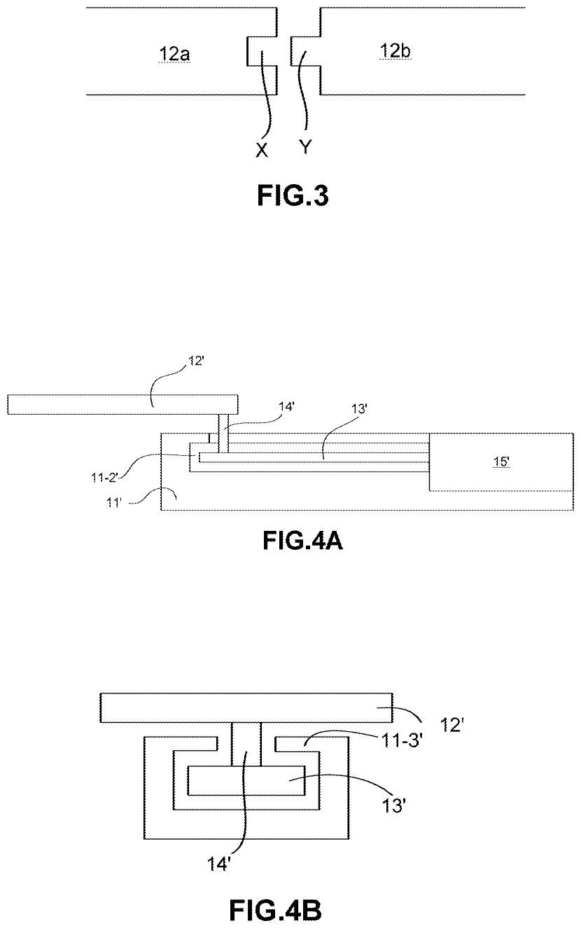

FIG. 3 illustrates a regional enlargement view of a cross section of neighboring blades according to some embodiments of the present disclosure. In some embodiments, a number of the plurality of blades 12a and 12b is at least four. The number of the plurality of blades 12a and 12b may be increased according to the requirement of the semiconductor fabrication process. Each of the plurality of blades 12a and 12b has a substantially identical shape and size with respect to each other. In some embodiments, each of the plurality of blades 12a and 12b are wedge shaped having a length greater than a radius of the central opening 11-1 of the valve port 11. To guarantee vacuum along the plurality of closed blades (e.g., blades 12a and 12b), the sidewalls of the plurality of blades 12a and 12b are textured, and the texture of neighboring blade sidewalls are designed to interlock with each other. In some embodiments, sidewalls of the plurality of blades 12a and 12b includes grooves X and protrusions Y. In an exemplary embodiment, the groove X and the protrusion Y of neighboring blades 12a and 12b are interlockable to each other. The number of grooves X and protrusions Y is not limited to that shown in FIG. 3. Furthermore, the shape of the grooves X and protrusions Y is not limited to that shown in FIG. 3 as well. The interlocking of the grooves X and protrusions Y allows the plurality of blades 12a and 12b to provide a seal in areas between the neighboring blades 12a and 12b. Thus, the pressure loss due to potential leak between the closed blades in the cover mechanism may be reduced.

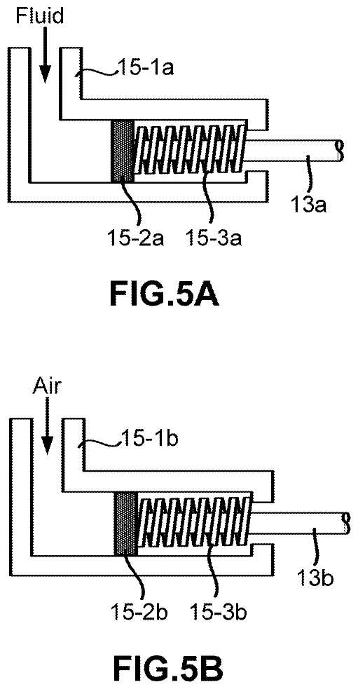

FIG. 4A illustrates a cross section of a cover mechanism according to some embodiments of the present disclosure. FIG. 4B illustrates another cross section of a cover mechanism according to some embodiments of the present disclosure. FIG. 4A may be taken along line AA′ in FIG.2 and FIG. 4B may be taken along line BB′. In some embodiments, the valve port 11′ further includes a plurality of railings 11-2′. The plurality of railing 11-2′ may be tracks formed in the valve port 11′ to accommodate the plurality of stems 13′. In other words, the plurality of stems 13′ are respectively disposed in the plurality of railings 11-2′ of the valve port 11′. The railings 11-2′ may act as a guide for the stem 13′ during operation. In some embodiments, the plurality of railing 11-2′ are recessed areas on the valve port 11′ formed to be perpendicular to a tangential line of the valve port 11′. In some embodiments, the railing 11-2′ does not penetrate through the inner periphery of the valve port 11′ (as shown in FIG. 4A). In some of the embodiments, each one of the plurality of railings 11-2′ has a flange 11-3′ to form an enclosed track for a stem of the plurality of stems 13′. In some embodiments, a blade 12′ of the plurality of blades 12′ is coupled to a corresponding stem 13′ of the plurality of stems 13′ through a fastener 14′. The flange 11-3′ defines an opening large enough to fit the fastener 14′ and allow the fastener 14′ to move along the railing 11-2′ but small enough to keep the stem 13′ within the railing 11-2′. In this way, the stem 13′ is anchored by the railing 11-2′ and prevent the stem 13′ from misaligning during opening and closing of the cover mechanism. In some other embodiments, the railing 11-2′ does penetrate through to the inner periphery of the valve port 11′. In this way, the length of the fastener 14′ may extend along the blade 12′ to increase stability of the blade' during movement. Nevertheless, the length of the stem 13′ may extend along the blade 12′ in the same way as the fastener 14′.

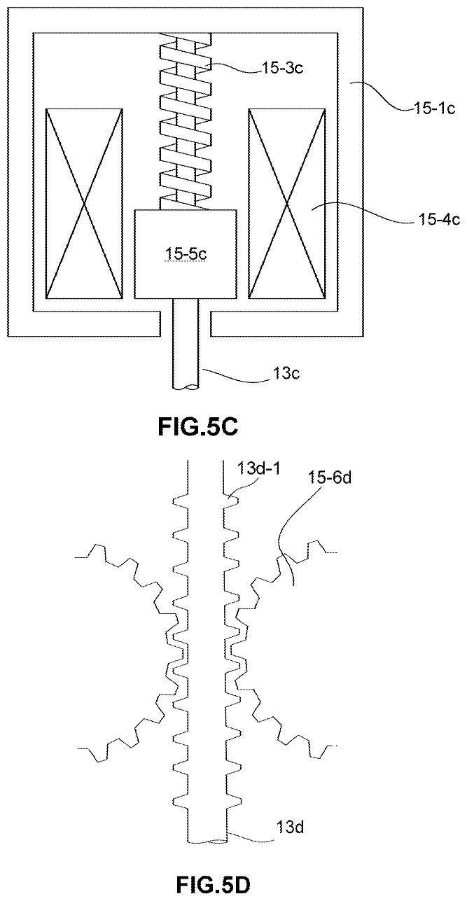

In some embodiments, each one of the plurality of stems 13 is coupled to a linear actuator. FIG. 5A-5D illustrates an actuator according to some embodiments of the present disclosure. The linear actuators may be one of types of actuators including a hydraulic actuator, a pneumatic actuator, an electrical actuator, and a mechanical actuator. FIG. 5A illustrates an exemplary embodiment of a hydraulic actuator according to some embodiments of the present disclosure. The hydraulic actuator includes of cylinder that uses hydraulic power to facilitate mechanical operation. The cylinder has a hollow cylindrical tube 15-1a along which a piston 15-2a slides. The piston 15-2a is physically coupled to the stem 13a to drive the movement of the stem 13a along the railing. During operation, a fluid is fed into the hollow cylindrical tube 15-1a to push the piston 15-2a and move the stem 13a along the hollow cylindrical tube 15-1a. A spring 15-3a is further disposed between the hollow cylindrical tube 15-1a and the piston 15-2a for retracting the stem 13a to its original position. FIG. 5B illustrates an exemplary embodiment of a pneumatic actuator according to some embodiments of the present disclosure. The pneumatic actuator includes cylinder that uses compressed gas to facilitate mechanical operation. The cylinder has a hollow cylindrical tube 15-1b along which a piston 15-2b slides. The piston 15-2b is physically couple to the stem 13b to drive the movement of the stem 13b along the railing. During operation, gas is fed into the hollow cylindrical tube 15-1b to push the piston 15-2b and move the stem 13a along the hollow cylindrical tube 15-1b. A spring 15-3b is further disposed between the hollow cylindrical tube 15-1b and the piston 15-2b for retracting the stem 13a to its original position. FIG. 5C illustrates an exemplary embodiment of an electrical actuator according to some embodiments of the present disclosure. An electrical actuator is an electromechanical device that converts electrical energy into mechanical energy. The electrical actuator includes a coil 15-4c, a spring 15-3c, and an armature 15-5c. The armature 15-5c is physically couple to the stem 13c to drive the movement of the stem 13c along the railing. The coil 15-4c is electrically coupled to an external supply current. When current flows into the coil 15-4c, magnetic field is formed to drive the movement of the armature 15-5c and, consequently, drive the movement of the stem 13c. The spring 15-3c is disposed between the hollow cylindrical tube 15-1c and the armature 15-2c for retracting the stem 13a to its original position. FIG. 5D illustrates an exemplary embodiment of an mechanical actuator according to some embodiments of the present disclosure. A mechanical actuator functions to execute movement by converting one kind of motion, such as rotary motion, into another kind, such as linear motion. The mechanical actuator includes a pinion 15-6d and a rack 13d-1 configured to engage with the pinion 15-6d. The pinion 15-6d may be a circular gear that rotates clockwise or counterclockwise depending on the direction of the movement of the stem 13d. The rack 13d-1 may be a linear gear that is a part of the stem 13d.

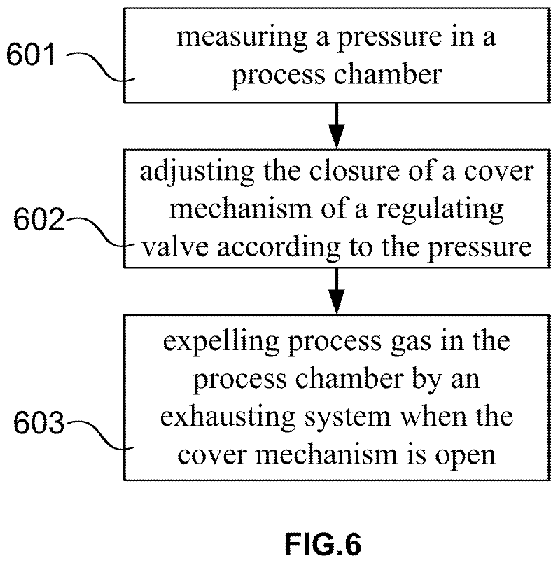

FIG. 6 illustrates a flowchart for a method of operating an apparatus according to some embodiments of the present disclosure. The method for operating the apparatus includes measuring a pressure in a process chamber (601), adjusting the closure of a cover mechanism of a regulating valve according to the pressure (602), and expelling process gas in the process chamber by an exhausting system when the cover mechanism is open (603). In some embodiments, the cover mechanism includes a valve port having a central opening, a plurality of blades symmetrically movable with respect to a center of the central opening between an open position and a closed position, a plurality of stems correspondingly coupled to the plurality of blades, and a controller configured to control the cover mechanism. Each of the plurality of stems are arranged perpendicular to a tangential line of the valve port. The plurality of stems is correspondingly coupled to linear actuators configured to control the motion of the plurality of stems. The linear actuators may be one of types of actuators including a hydraulic actuator, a pneumatic actuator, an electrical actuator, and a mechanical actuator. In some embodiments, the linear actuators are controlled by the controller to perform a same action at substantially a same time. When the cover mechanism is open, the plurality of blades are at a same distance from a center of the valve port and the plurality of blades form a plurality of line segment openings intersecting at a center of the valve port. In this way, the opening formed by the plurality of blades during open position may provide uniform exhausting to through the exhaust pipe and further into the process chamber. Sidewalls of the plurality of blades have grooves and protrusions. The grooves and the protrusions of neighboring blades interlock to each other to maintain vacuum and pressure during close position. In some embodiments, the plurality of stems are correspondingly disposed in a plurality of railings of the valve port. Each of the plurality of railings having a flange to form an enclosed track for a stem of the plurality of stems. A blade of the plurality of blades is coupled to a corresponding stem of the plurality of stems using a fastener. The opening formed by the flanges are big enough to allow the fastener to move along the railing and small enough to keep the stem within the enclosed space of the railing. In some embodiments, each of the plurality of blades have substantially identical shape and size. Each of the plurality of blades may be wedge shaped.

Accordingly, one aspect of the instant disclosure provides a regulating valve structure that comprises a cover mechanism comprising a valve port having a central opening, a plurality of blades symmetrically movable with respect to a center of the central opening between an open position and a closed position, and a plurality of stems correspondingly coupled to the plurality of blades, each of the plurality of stems being arranged perpendicular to a tangential line of the valve port, and a controller coupled to the cover mechanism.

In some embodiments, the valve port further comprises a plurality of railings, wherein the plurality of stems are respectively disposed in the plurality of railings of the valve port.

In some embodiments, each of the plurality of railings has a flange to form an enclosed track for a stem of the plurality of stems.

In some embodiments, each of the plurality of stems is coupled to a linear actuator.

In some embodiments, the linear actuators are one of types of actuators including a hydraulic actuator, a pneumatic actuator, an electrical actuator, and a mechanical actuator.

In some embodiments, when the cover mechanism is in the open position, the plurality of blades are arranged at a same distance from a center of the valve port, and the plurality of blades form a plurality of line segment openings intersecting at a center of the valve port.

In some embodiments, sidewalls of the plurality of blades includes grooves and protrusions and the grooves and the protrusions of neighboring blades interlock to each other.

In some embodiments, each of the plurality of blades are wedge shaped having a length greater than a radius of the central opening of the valve port.

In some embodiments, a blade of the plurality of blades is coupled to a corresponding stem of the plurality of stems using a fastener.

In some embodiments, each of the plurality of blades have a same shape and a same size from each other.

Accordingly, another aspect of the instant disclosure provides a method of operating an apparatus that comprises measuring a pressure in a process chamber, adjusting the closure of a cover mechanism of a regulating valve according to the pressure, wherein the cover mechanism comprises a valve port having a central opening, a plurality of blades symmetrically movable with respect to a center of the central opening between an open position and a closed position, a plurality of stems correspondingly coupled to the plurality of blades, each of the plurality of stems being arranged perpendicular to a tangential line of the valve port, and a controller configured to control the cover mechanism, and, when the cover mechanism is open, expelling process gas in the process chamber by an exhausting system.

In some embodiments, the plurality of stems is correspondingly coupled to linear actuators.

In some embodiments, the linear actuators are one of types of actuators including a hydraulic actuator, a pneumatic actuator, an electrical actuator, and a mechanical actuator.

In some embodiments, the linear actuators are controlled by the controller to perform a same action at substantially a same time.

In some embodiments, when the cover mechanism is open, the plurality of blades are at a same distance from a center of the valve port and the plurality of blades form a plurality of line segment openings intersecting at a center of the valve port.

In some embodiments, sidewalls of the plurality of blades includes grooves and protrusions and the grooves and the protrusions of neighboring blades interlock to each other.

In some embodiments, the plurality of stems are correspondingly disposed in a plurality of railings of the valve port.

In some embodiments, each of the plurality of railings having a flange to form an enclosed track for a stem of the plurality of stems.

In some embodiments, a blade of the plurality of blades is coupled to a corresponding stem of the plurality of stems using a fastener.

In some embodiments, each of the plurality of blades have substantially identical shape and size.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A regulating valve structure, comprising:
a cover mechanism, comprising:
a valve port having a central opening;
a plurality of blades symmetrically movable with respect to a center of the central opening between an open position and a closed position; and
a plurality of stems correspondingly coupled to the plurality of blades, each of the plurality of stems being arranged perpendicular to a tangential line of the valve port; and
a controller coupled to the cover mechanism.

2. The structure of claim 1, wherein the valve port further comprises a plurality of railings, wherein the plurality of stems are respectively disposed in the plurality of railings of the valve port.

3. The structure of claim 2, wherein each of the plurality of railings has a flange to form an enclosed track for a stem of the plurality of stems.

4. The structure of claim 1, wherein each of the plurality of stems is coupled to a linear actuator.

5. The structure of claim 4, wherein the linear actuators are one of types of actuators including a hydraulic actuator, a pneumatic actuator, an electrical actuator, and a mechanical actuator.

6. The structure of claim 1, wherein when the cover mechanism is in the open position, the plurality of blades are arranged at a same distance from a center of the valve port, and the plurality of blades form a plurality of line segment openings intersecting at a center of the valve port.

7. The structure of claim 1, wherein sidewalls of the plurality of blades includes grooves and protrusions and the grooves and the protrusions of neighboring blades interlock to each other.

8. The structure of claim 1, wherein each of the plurality of blades are wedge shaped having a length greater than a radius of the central opening of the valve port.

9. The structure of claim 1, wherein a blade of the plurality of blades is coupled to a corresponding stem of the plurality of stems using a fastener.

10. The structure of claim 1, wherein each of the plurality of blades have a same shape and a same size from each other.

11. A method of operating an apparatus, comprising:
measuring a pressure in a process chamber;
adjusting the closure of a cover mechanism of a regulating valve according to the pressure, wherein the cover mechanism comprises:
a valve port having a central opening;
a plurality of blades symmetrically movable with respect to a center of the central opening between an open position and a closed position;
a plurality of stems correspondingly coupled to the plurality of blades, each of the plurality of stems being arranged perpendicular to a tangential line of the valve port; and
a controller configured to control the cover mechanism; and
when the cover mechanism is open, expelling process gas in the process chamber by an exhausting system.

12. The method of claim 11, wherein the plurality of stems is correspondingly coupled to linear actuators.

13. The method of claim 12, wherein the linear actuators are one of types of actuators including a hydraulic actuator, a pneumatic actuator, an electrical actuator, and a mechanical actuator.

14. The method of claim 12, wherein the linear actuators are controlled by the controller to perform a same action at substantially a same time.

15. The method of claim 11, wherein when the cover mechanism is open, the plurality of blades are at a same distance from a center of the valve port and the plurality of blades form a plurality of line segment openings intersecting at a center of the valve port.

16. The method of claim 11, wherein sidewalls of the plurality of blades includes grooves and protrusions and the grooves and the protrusions of neighboring blades interlock to each other.

17. The method of claim 11, wherein the plurality of stems are correspondingly disposed in a plurality of railings of the valve port.

18. The method of claim 17, wherein each of the plurality of railings having a flange to form an enclosed track for a stem of the plurality of stems.

19. The method of claim 11, wherein a blade of the plurality of blades is coupled to a corresponding stem of the plurality of stems using a fastener.

20. The method of claim 11, wherein each of the plurality of blades have substantially identical shape and size.
